(19) United States
(12) Patent Application Publication
(10) Pub. No.: US 2026/0091832 A1
(43) Pub. Date: Apr. 2, 2026

(54) SPARE TIRE HOLDER

(71) Applicant: Philip E. DROUIN, Acworth, NH (US)

(72) Inventor: Philip E. DROUIN, Acworth, NH (US)

(21) Appl. No.: 18/954,934

(22) Filed: Nov. 21, 2024

Related U.S. Application Data
(60) Provisional application No. 63/702,403, filed on Oct. 2, 2024.

(51) Int. Cl. B62D 43/02; B60D 1/58

(52) U.S. Cl. CPC B62D 43/02; B60D 1/58

(57) ABSTRACT

Disclosed is a spare tire holder configured to be mounted to a trailer hitch receiver of a vehicle. The spare tire holder can have an additional hitch receiver that is shaped to receive a hitch or hitch adapter. The hitch receiver can be attached to one end of a support arm that extends laterally, and the other end of the support arm can be attached to a mounting bracket. A wheel mounting portion can be attached at one end to the mounting bracket and attached to a wheel mounting portion at a second end. The wheel mounting portion can pivot between an upright position and a lowered position. A lateral position of the wheel mounting portion can adjustable.

### RELATED APPLICATIONS

This application claims the benefit under 35 U.S.C. § 119 (e) of U.S. Provisional Patent Application No. 63/702,403 titled SPARE TIRE HOLDER, and filed on Oct. 2, 2024, the contents of which are incorporated herein by reference in its entirety.

### TECHNICAL FIELD

The present disclosure relates generally to a spare tire holder for a vehicle.

### BACKGROUND

A spare tire is typically mounted to a rim and often kept with the vehicle in case one of the main tires is damaged unexpectedly while driving. Spare tires for pickup trucks and sport utility vehicles are often stowed underneath the truck bed or rear of the vehicle. In some instances, a jack may be necessary to lift the vehicle so that a user can remove the tire. For other vehicles, the spare tire can be mounted to a swingarm that is pivotably connected to the rear of the vehicle, such as jeeps and utility vehicles. In such embodiments, the spare tire is mounted on a wheel that is secured to the swingarm. In its stowed position, the swingarm extends across the rear end of the vehicle. For yet other vehicles, the spare tire is stored in a compartment in the trunk or in the floor in the rear part of the vehicle's cabin.

### BRIEF DESCRIPTION OF THE DRAWINGS

FIG. 1 illustrates a perspective view of spare tire holder with a spare tire attached, in accordance with an embodiment of the present disclosure.

FIG. 2 is a perspective view showing a spare tire holder from a mounting side, in accordance with an embodiment of the present disclosure.

FIG. 3 illustrates a wheel mounting portion of a spare tire holder in a first position, in accordance with an embodiment of the present disclosure.

FIG. 4 illustrates a wheel mounting portion of a spare tire holder in a second position, in accordance with an embodiment of the present disclosure.

FIG. 5 is an exploded view of a wheel mounting portion, in accordance with an embodiment of the present disclosure.

FIG. 6 illustrates a hitch receiver of a spare tire holder and a hitch adapter, in accordance with an embodiment of the present disclosure.

FIG. 7 illustrates an embodiment of a spare tire holder with a second hitch receiver, in accordance with an embodiment of the present disclosure.

FIG. 8 is a partially exploded view of a first end of a support arm and hitch adapter, in accordance with an embodiment of the present disclosure.

FIG. 9 is a side view showing a partially exploded view of a hitch received in a hitch receiver, in accordance with an embodiment of the present disclosure.

The figures depict various embodiments of the present disclosure for purposes of illustration only. Numerous variations, configurations, and other embodiments will be apparent from the following detailed discussion.

### DETAILED DESCRIPTION

Disclosed is a holder for a spare tire that can be mounted in a vehicle trailer hitch receiver. In one example embodiment, the holder includes a support arm extending laterally between a first end and a second end, where the second end has a mounting bracket. A wheel mounting portion is pivotably attached to the mounting bracket, thereby enabling the wheel mounting portion to pivot between a first position (e.g., an upright position) and a second position (e.g., a lowered or folded position). The wheel mounting portion is configured to attach to the wheel of a mounted spare tire and is configured to pivot to accommodate tires of different sizes and to avoid the tire blocking brake lights of the host vehicle. The spare tire holder can have an additional hitch receiver that is shaped to receive an additional hitch tongue or tongue of a hitch adapter. For example, the additional hitch receiver can be attached near the first end of the support arm. In some embodiments, the support arm can translate laterally, such as by advancing a screw drive or the like.

A spare tire can be any kind of tire that a user wishes to keep with the vehicle, including a full-sized tire that matches the regular tires on the vehicle, a temporary or emergency spare tire for the vehicle, or a tire for another machine that the vehicle is towing or carrying such as an all-terrain vehicle, a motorcycle, or a trailer.

### Overview

Removing a spare tire from beneath a truck or other vehicle can be difficult or inconvenient because the user has to crawl under the vehicle to remove the tire. Additionally, in cold weather, fasteners retaining the tire can freeze under the truck, making the tire difficult to remove. Further, if the vehicle becomes stuck in mud or rests on uneven ground, removing the tire from beneath the vehicle may be very difficult or impossible because access to the tire may be blocked and/or the tire may be wedged between the ground and the vehicle.

Existing swingarm mounts have alleviated some difficulties with stowing a spare tire, but other challenges remain. For example, a swingarm on the rear of a towing vehicle can interfere with a trailer and may interfere with opening a tailgate or rear door of the vehicle. Tire mounts on the center of a tailgate can prevent opening a tailgate due to interference between the tire and the trailer hitch or trailer tongue.

In light of the foregoing challenges, a need exists for improvements to a holder for a mounted vehicle tire (a “spare tire”). The present disclosure addresses this need and others by providing a spare tire holder that can be mounted in a vehicle trailer hitch receiver. In some embodiments, the spare tire holder enables position adjustment of the tire, including one or more of pivot adjustment of the wheel mounting portion, folding between up and down positions, and lateral translation of the wheel mounting portion.

In some embodiments, the wheel mounting portion can tilt down in order to provide clearance for opening a tailgate or rear door of a vehicle. Numerous variations and embodiments will be apparent in light of the present disclosure. In some embodiments, the spare tire holder enables lateral position adjustment and/or other position adjustment of the tire when mounted on the spare tire holder. For example, the wheel mounting portion can include a plate and a pivot arm. An opening in the plate is shaped to receive an adjustment pin and an opening in the pivot arm shaped to receive the adjustment pin. When the adjustment pin is received by both openings, the adjustment pin can secure the plate from pivoting relative to the pivot arm. In some embodiments, the plate has two or more openings. The plate opening can include openings to pivotably adjust the position of the spare tire holder for various sizes of spare tires. The plate opening can also include openings to adjust the clearance of the spare tire with respect to the host vehicle brake lights or components of a trailer hooked to a trailer ball on the mounting assembly, for example.

In some embodiments, the wheel mounting portion of the spare tire holder can tilt down, such as to provide clearance for opening a tailgate or rear door of a vehicle. This can occur with or without the spare tire being secured to the mounting portion. In one example, the wheel mounting portion can be pivotably attached to the mounting bracket at a second end of the support arm, thereby enabling the wheel mounting portion to pivot between a first position and a second position. The wheel mounting portion can include a pivot arm extending from a first end to a second end. The first end can be attached to the remainder of the wheel mounting portion, and the second end can be pivotally attached to the mounting bracket.

In some embodiments, the pivot arm can include an attachment bracket and the mounting bracket can include an attachment post. One or more springs can be shaped to connect to the attachment bracket at a first end of the spring and to the attachment post at a second end of the spring. When the spring is attached to the attachment bracket and the attachment post, the spring(s) can create tension that pulls or biases the pivot arm, or assists in moving the pivot arm, towards an upright position or towards the spring side of the pivot arm. The mounting bracket can include one or more retaining hole sized and shaped to receive a pin. In the first position of the wheel mounting portion, the pin can be received in a first retaining hole, and in the second position of the wheel mounting portion, the pin can be received in a second retaining hole. In both the first and second position, the pin can extend across the pivot arm and function as a stop to prevent the pivot arm from moving beyond the pin towards a wheel side of the spare tire holder.

In some embodiments, the spare tire holder includes a second hitch receiver so that a user can tow a trailer or other attachment without having to remove the spare tire holder.

The present disclosure is discussed in the context of a spare tire that is mounted to a wheel. Accordingly, the term “spare tire” refers to a tire mounted to a wheel, rather than an unmounted tire, unless otherwise specified. The present disclosure is not limited, however, to a mounted tire and can also be used with a wheel with no tire mounted to it as well as with other objects that can be retained on the spare tire holder in place of a wheel or mounted spare tire. Numerous variations and embodiments will be apparent in light of the present disclosure.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the disclosed subject matter.

### Example Embodiments

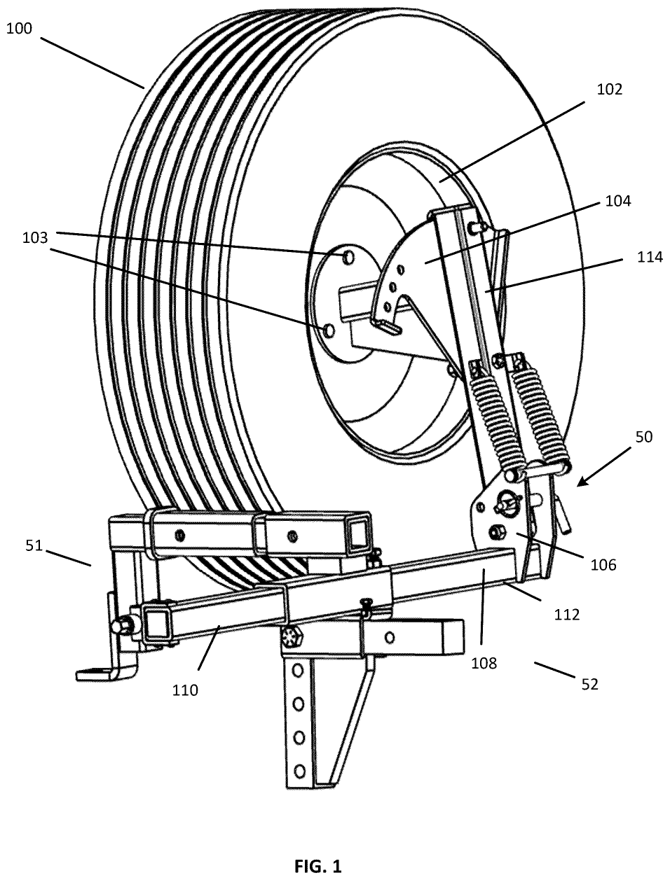

FIG. 1 illustrates a perspective view of a spare tire holder 50 with a spare tire 100 secured to the holder 50, in accordance with an embodiment of the present disclosure. The spare tire holder 50 has a wheel side 51 and a mounting side 52. In this example, the spare tire 100 includes a tire 101 mounted to a wheel 102. The spare tire 100 can be attached to wheel mounting portion 104 via the wheel 102 of the spare tire 100. For example, the wheel 102 can be attached by bolts or other suitable fasteners 103 that extend through the wheel 102 and the wheel mounting portion 104.

In some embodiments, such as shown here, the wheel mounting portion 104 can be removably or adjustably attached to the mounting bracket 106. In this example, the wheel mounting portion 104 is pivotably attached to a pivot arm 114 that extends between and connects the wheel mounting portion 104 to the mounting bracket 106. The wheel mounting portion 104 can be in a first position or a second position. The first position can be an upright position where the spare tire is stowed against a rear side of a vehicle. The second position can be a lowered position where the tire is tilted down to provide clearance for opening a tailgate or rear door of a vehicle. The mounting bracket 106 can be attached to support arm 108 at a second end 112. In other embodiments, the wheel mounting portion 104 is fixed to the pivot arm 114 and/or can be made as one piece with the pivot arm 114. Additionally, the wheel mounting portion 104 can pivot with respect to the pivot arm 114 as needed to accommodate tires of different sizes and to move the mounted spare tire so as to not block brake lights of the host vehicle. In one embodiment, some openings in the mounting portion are configured for positioning a mounted spare tire based on the diameter of the spare tire, while other openings in the mounting portion are for pivoting the spare tire to a clearance position with respect to the vehicle brake lights.

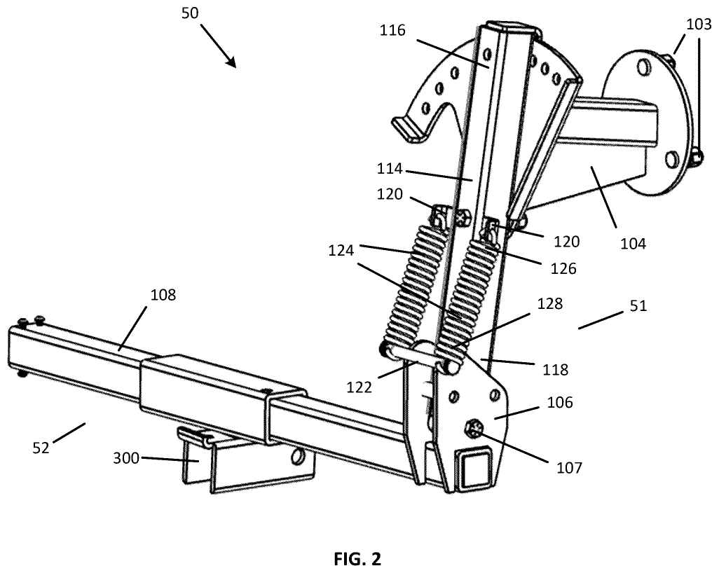

FIG. 2 is a perspective view showing a spare tire holder 50 with wheel mounting portion 104 as viewed from a mounting side 52, in accordance with another embodiment of the present disclosure. The wheel mounting portion 104 can be adjustably attached to pivot arm 114 that connects to the mounting bracket 106. For example, the pivot arm 114 can be pivotably attached to the mounting bracket 106 by bolt 107, pin, or some other suitable fastener. In this example, the pivot arm 114 has a first end 116 that is attached to wheel mounting portion 104. The pivot arm has a second end 118 that is attached to mounting bracket 106. The second end 118 of the pivot arm 114 can be pivotably attached to the mounting bracket 106. At the second end 118 of the pivot arm 114, the bolt 107 can be received through an opening in the mounting bracket 106 and through an opening in the pivot arm 114, allowing the pivot arm 114 to pivot around the bolt relative to the mounting bracket 106.

The pivot arm 114 can have a spring attachment bracket 120. In one embodiment, the spring attachment bracket 120 can be located on a side of the pivot arm 114 opposite the wheel mounting portion 104. Mounting bracket 106 can have a spring attachment post 122 extending crosswise to the mounting bracket 106. A spring 124 can have a first end 126 and a second end 128. The spring 124 can be shaped to attach at first end 126 to the attachment bracket 120 on the pivot arm 114, and at second end 128 to attachment post 122 on the mounting bracket 106. The spring 124 can be a coil spring or otherwise shaped so that it can extend between the attachment bracket 120 and the attachment post 122 when the wheel mounting portion 104 is in the first or second position. When the spring 124 is attached to the attachment bracket 120 and the attachment post 122, the spring 124 can create tension that pulls or biases the pivot arm 114 towards an upright position with respect to the mounting bracket 106. In some embodiments, two or more attachment brackets 120 and two or more springs 124 are included. For example, each spring 124 can extend from a separate attachment bracket 120 at its first end 126 to the attachment post 122 at its second end 128. In this example, the spare tire holder 50 includes two springs 124 attached in parallel between the attachment post 122 and respective attachment brackets 120 on the pivot arm 114. Although coil springs are shown in this example, other springs, such as a torsion spring, can be used.

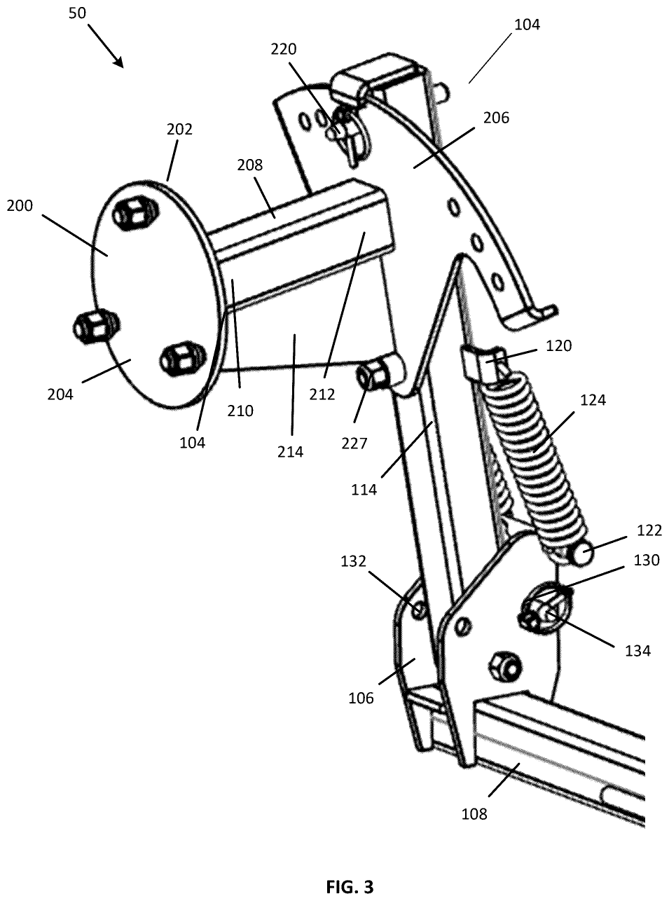

FIG. 3 shows a perspective view of the wheel mounting portion 104 of a spare tire holder 50 in an upright or first position, in accordance with an embodiment of the present disclosure. The first position can be an upright position. For example, in the upright position the tire 100 is spaced from the rear end of the vehicle and is generally oriented in a vertical plane, ±15° for example.

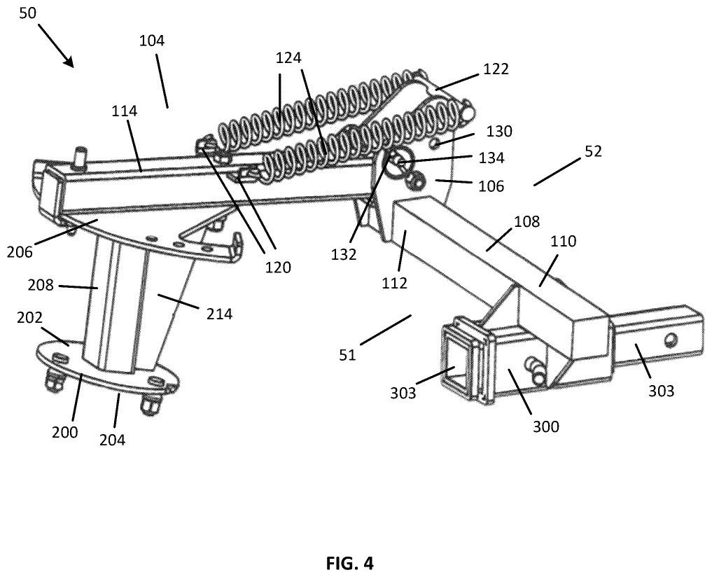

FIG. 4 shows the wheel mounting portion 104 in a lowered or second position. The second position can be a lowered position where the wheel mounting portion 104 is tilted down and the pivot arm 114 extends generally horizontally (±5-15°) to provide clearance for opening a tailgate or rear door of a vehicle. For example, the pivot arm 114 extends generally parallel to the hitch receiver 300 so that a spare tire mounted to the wheel mounting portion 104 is positioned below the pivot arm 114 and out of the way of a tailgate or rear door of a vehicle.

The mounting bracket 106 can include a first retaining hole 130 and a second retaining hole 132 each shaped to receive a pin 134. When the wheel mounting portion 104 is in the first position, the pin 134 can be received in the first retaining hole 130 to fix the upright position of the pivot arm 114. When the wheel mounting portion 104 is in the second position, the pin 134 can be received by the second retaining hole 132 to fix the generally horizontal position of the pivot arm 114 and to prevent the pivot arm 114 from inadvertently returning to the upright position due to spring tension. In both the first and second position, the pin can extend crosswise to the pivot arm 114 to prevent the pivot arm 114 and wheel mounting portion 104 from moving beyond the pin 134 towards the wheel side 51 of the spare tire holder. In some embodiments, there can be two or more first retaining holes 130 or second retaining holes 132 so as to provide several positions of the pivot arm 114. For example, holes 132 can be arranged to maintain the pivot arm in a horizontal position, at an angle of about 30° to the horizontal, at an angle of about 45° to the horizontal, and at an angle of about 60° to the horizontal. One of the two or more first retaining holes 130 can align with another first retaining hole 130. The pin 134 can be received by both of the first retaining holes 130. One of the two or more second retaining holes 132 can align with another second retaining hole 132. The pin 134 can be received by both of the second retaining holes 132.

The wheel mounting portion 104 can include a mounting plate 200, a support plate 206 spaced from the mounting plate 200, and a beam 208 extending between and connecting the mounting plate to the support plate 206. The mounting plate 200 can have a mounting side 202 and a wheel side 204. The mounting plate 200 can be configured to attach to the wheel 102 of a spare tire 100. The wheel can be attached using lug nuts attached to lug nut studs, or other suitable fasteners 103. Beam 208 can extend longitudinally from a first end 210 to a second end 212. The first end 210 can attach to the mounting side 202 of the mounting plate 200 and the second end 212 can attach to the support plate 206 so that the beam 208 connects and is positioned between the mounting plate 200 and the support plate 206. In some embodiments, the beam 208 is welded to each of the mounting plate 200 and the support plate 206.

A beam gusset 214 can be attached to beam 208 and extend longitudinally from a first end to a second end. The first end can be attached to the mounting side 202 of the mounting plate 200 and the second end attached to the support plate 206 so that the beam gusset 214 connects and is positioned between the mounting plate 200 and the support plate 206. The beam gusset 214 is optional in some embodiments, but it can be provided for increased structural stiffness.

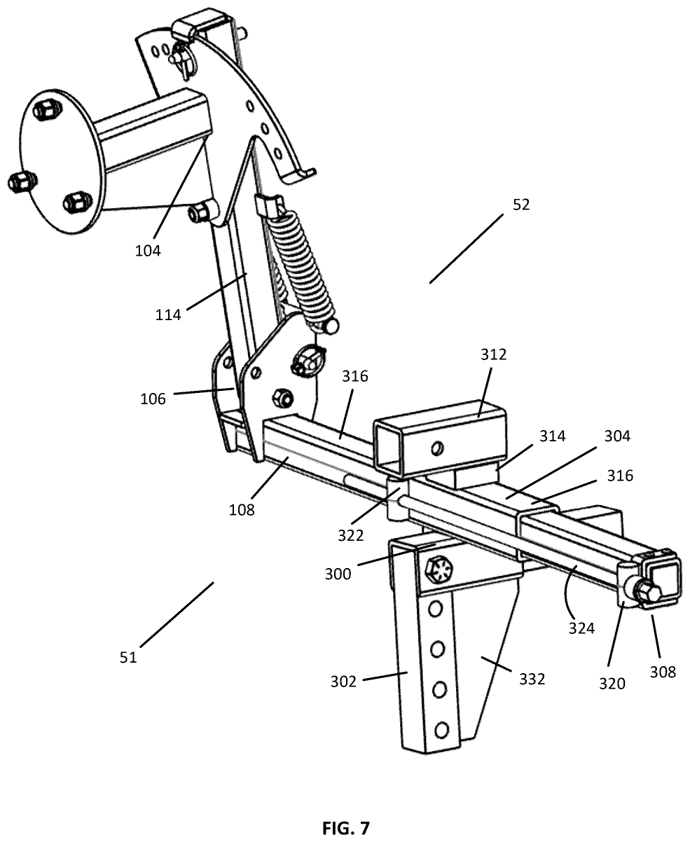

FIG. 4 also illustrates a hitch adapter 303 received in hitch receiver 300 of the spare tire holder. The hitch receiver 300 is sized to receive a tube of the hitch adapter 303. For example, the hitch receiver 300 has a 2.5″×2.5″ tube that accepts a 2″×2″ tube of the hitch adapter 303. The hitch adapter 303 can have a first end and a second end. The first end can be oriented towards the wheel side 51 of the spare tire holder 50, and the second end can be oriented towards the mounting side 52 of the spare tire holder 50. The second end can be sized and shaped to fit into a standard vehicle trailer hitch receiver, such as any commercially available vehicle hitch receiver. The first end can be shaped to receive a hitch 302 such as a drop-down hitch adapter 302 (e.g., shown in FIG. 7). A drop-down hitch adapter 302 can be used so that the trailer ball is at the appropriate height to tow a trailer or other attachment. The hitch adapter 303 can be received in hitch receiver 300 to change the dimensions of the receiver tube to accommodate hitches 302 of various sizes. The hitch adapter 303 can be shaped such that, when received in hitch receiver 300, the hitch adapter increases the clearance between a rear side of a vehicle and the hitch receiver 300. In some embodiments, the hitch adapter 303 can be included in place of the hitch receiver 300.

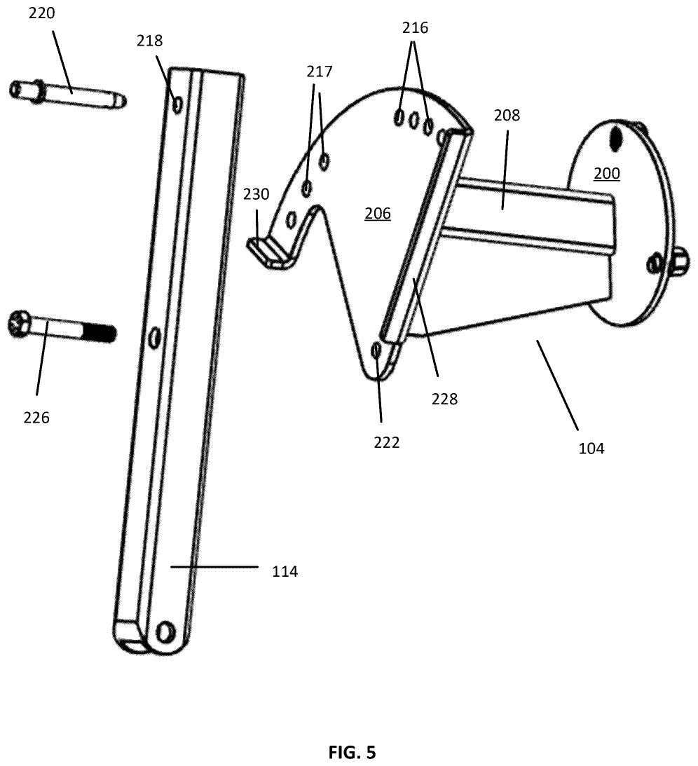

FIG. 5 is an exploded view of a wheel mounting portion 104 and pivot arm 114, in accordance with an embodiment of the present disclosure. As noted above, the wheel mounting portion 104 can be pivotably attached to the pivot arm 114. In this example, the support plate 206 can be pivotably attached to pivot arm 114. The support plate 206 can have a main opening 222 shaped to receive a fastener 226. The pivot arm 114 can have a main opening 224 shaped to receive the fastener 226. When the fastener 226 is received by both the main opening 222 in the support plate 206 and the main opening 222 in the pivot arm 114, the support plate 206 can pivot around the fastener 226 relative to the pivot arm 114. In one embodiment, the fastener 226 can be a bolt or pin, for example. A nut can be screwed onto the bolt to secure the support plate 206 from pivoting relative to the pivot arm 114. In other embodiments, the nut can be omitted, and the fastener can be threaded into a threaded bushing on the pivot arm 114.

The support plate 206 can have one or more additional openings 216, 217 shaped to receive an adjustment pin 220 or fastener, where each additional opening 216, 217 is spaced from the main opening 222, such as at an opposite side of the support plate 206. In this example, the support plate 206 generally has a sector shape or wedge shape with the main opening located adjacent a vertex of the support plate 206 and additional openings 216, 217 distributed along an opposite outer edge of the support plate 206. The pivot arm 114 can have an opening 218 shaped to receive the adjustment pin 220. The opening 218 in the pivot arm can extend through the pivot arm 114. When the adjustment pin 220 is received by both the opening 216 in the support plate 206 and the opening 218 in the pivot arm 114, the adjustment pin 220 can secure the support plate 206 from pivoting relative to the pivot arm 114.

The opening 218 in the pivot arm 114 can include a bushing, which can reduce the friction on the adjustment pin 220 and/or make it easier to move the adjustment pin 220 in and out of the opening 218. In another embodiment, the bushing can be shaped so that adjustment pin 220 fits snuggly into the opening 218. This can further secure the support plate 206 from pivoting relative to the pivot arm 114 when the adjustment pin 220 is received through openings 216 and 218.

In some embodiments, the support plate 206 defines two or more plate openings 216 configured to adjust position of the plate 206 for a given tire size. Each of the plate openings 216 can receive the adjustment pin 220 to secure the support plate 206 in a different pivoted position relative to the pivot arm 114. The various plate openings 216 can be used to adjust the spare tire holder 50 for various sizes of spare tires 100 and/or to position the spare tire 100 as needed when installed on the vehicle. The plate openings 217 can be used to adjust the clearance of the spare tire with respect to a vehicle or towed vehicle, such as to avoid a rear-view camera or to avoid the vehicle's brake lights, for example, as deemed appropriate.

The support plate 206 can include a first stop 228, such as a raised edge shown in this example. The first stop 228 can be located on an opposite side of the support plate 206 from the beam 208. The first stop 228 can be shaped to stop the support plate 206 from pivoting relative to the pivot arm 114. When the support plate 206 is pivoted to the first stop 228, the first stop can contact the pivot arm 114 adjacent to the side that contacts the support plate 206. The support plate 206 can also include a second stop 230 configured in this example as a raised edge or tab. The second stop 230 can be located on an opposite side of the support plate 206 from the first stop 228. When the support plate 206 is pivoted to the second stop 230, the second stop 230 can catch on the pivot arm 114 by coming into contact with a side of the pivot arm 114 adjacent to the side that contacts the support plate 206.

In some embodiments, the support plate 206 pivots about main opening 222 (or fastener installed in opening 222) to adjust the position of the wheel mounting portion 104 towards or away from a passenger side of the vehicle. For example, support plate 206 can pivot about opening 222 and be secured with a fastener in one of additional openings 216, such as to accommodate a larger or smaller tire or to position the tire to avoid interfering with a backup camera, brake lights, propane tanks on a trailer, trailer jack, or other aspect of the vehicle or a towed vehicle. In some embodiments, the support plate 206 includes additional openings 216 to accommodate spare tires of 35″ or greater size.

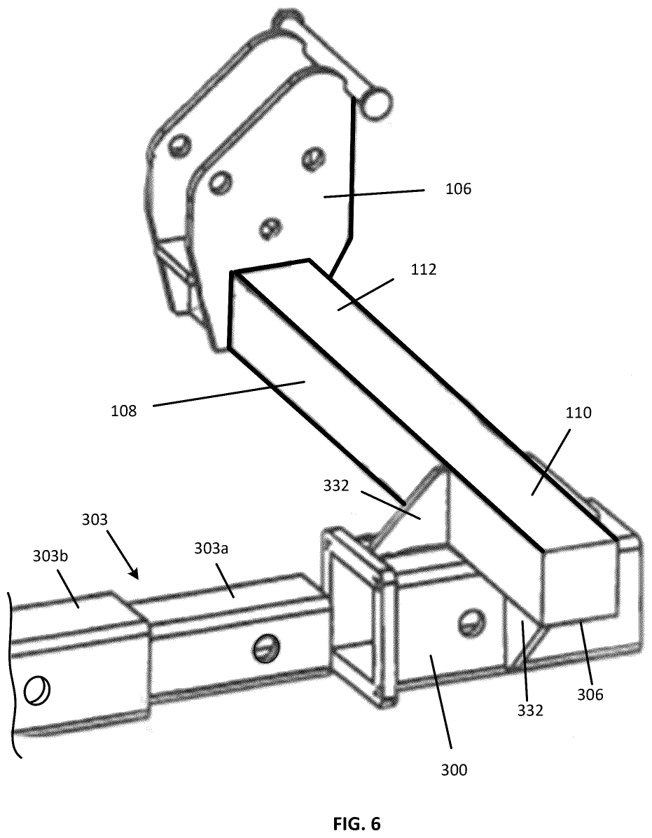

FIG. 6 illustrates a hitch receiver 300 of a spare tire holder 50 along with a hitch adapter 303, in accordance with an embodiment of the present disclosure. In some embodiments, the hitch receiver 300 can be at the first end 110 or first end portion of the support arm 108. In such position, a spare tire 100 (shown in FIG. 1) is laterally offset from the hitch receiver 300 so as to provide clearance with the hitch receiver 300. In other embodiments, the hitch receiver 300 can be located along a middle portion or other region of the support arm 108. In some embodiments, the support arm 112 is movably attached to the hitch receiver 300 so that the lateral position of the mounting bracket 106 can be adjusted as needed. The hitch receiver 300 can be attached to a bottom side 306 of the support arm 112, for example. The hitch receiver 300 can be shaped to receive a hitch 302, which can be any commercially available hitch. The hitch 302 can be the trailer hitch of a vehicle. In some embodiments, the hitch 302 can be drop down hitch adapter configured so that the hitch 302 is at the appropriate height to tow a trailer or other attachment.

The hitch receiver 300 can have a tubular shape, such as a square tube, that is configured to receive a hitch adapter 303, which can be any commercially available hitch adapter. The hitch adapter 303 can have a first side and a second side. The first side can be oriented towards the wheel side 51 of the spare tire holder 50, and the second side can be oriented towards the mounting side 52 of the spare tire holder 50. The second side can be shaped to fit into a vehicle trailer hitch receiver. The first side can be shaped to receive a hitch 302 such as a drop-down hitch. A drop-down hitch can be used so that the hitch 302 is at the appropriate height to tow a trailer or other attachment. The hitch adapter 303 (sometimes referred to as a “receiver adapter and extender” or “drop-down hitch adapter”) can be received in hitch receiver 300 to change the dimensions of the receiver tube to accommodate hitches 302 of various sizes, to extend the position of the receiver, and/or to change the vertical position of the receiver. In this example, the hitch adapter 303 includes a tongue portion 303a and a receiver portion 303b. The tongue portion 303a can be received in the receiver 300 and retained using one or more pins. The receiver portion 303b is sized to receive a tongue of a trailer hitch assembly, a bike rack, or other receiver-mounted accessory. The hitch adapter 303 can be shaped such that, when received in hitch receiver 300, the hitch adapter increases the clearance between a rear side of a vehicle and the hitch receiver 300. In some embodiments, the hitch adapter 303 can be included in place of the hitch receiver 300.

The hitch receiver 300 can be mounted to the support arm 108 so that a hitch 302 received by the hitch receiver 300 extends transversely (e.g., perpendicularly) from the support arm 108 on a mounting side 52 of the spare tire holder 50. A top side 310 of hitch receiver 300 can be attached to a bottom side 308 of the attachment assembly 304 (shown in FIG. 7 and discussed below).

In some embodiments, a support arm gusset 332 can connect the support arm 108 to the hitch receiver 300. For example, the support arm gusset 332 can connect a side of the support arm 108 to a top side of the hitch receiver 300 and reinforce the structural stiffness. The support arm gusset 332 can connect a bottom side of the support arm to a side of the hitch receiver. The support arm gusset 332 can strengthen and stabilize the connection between the support arm 108 and the hitch receiver 300. Two or more support arm gussets 332 can be included in some embodiments. In another embodiment, a support arm gusset 332 can be positioned between an attachment assembly 304 and a hitch receiver 300. The support arm gusset 332 can connect a bottom side 308 of the attachment assembly to a side of the hitch receiver 300. The support arm gusset 332 can strengthen and stabilize the connection between the attachment assembly 304 the hitch receiver 300.

In use, the hitch adapter 303 can be secured to the vehicle's hitch receiver using a pin that extends through the opening in the tongue portion 303a, while securing the receiver portion 303b to the hitch receiver 300 using a pin that extends through the respective openings in the hitch receiver 300 and the receiver portion 303b. A bike rack or trailer ball assembly, for example, can then be received in the receiver portion 303b of the hitch adapter 303. In other applications, such as in a heavy-duty embodiment as shown in FIG. 7, the tongue portion 303a of the hitch adapter 303 can be received in the additional receiver 312 on top of the support arm 108 and pinned through respective openings in the additional hitch receiver 312 and tongue portion 303a. In some embodiments, when towing a trailer or mounting a bike rack to the spare tire holder 50, for example, the hitch adapter 303 can be removed and replaced with the tongue of the trailer ball assembly, bike rack, or other equipment.

FIG. 7 illustrates a perspective view of a spare tire holder 50 with the pivot arm 114 in an upright position, in accordance with another embodiment of the present disclosure. In this example, the spare tire holder 50 includes an attachment assembly 304 that is shaped to receive the support arm 108 and enable lateral position adjustment of the pivot arm 114. The attachment assembly 304 includes a hollow tube 316 sized to slidingly receive the support arm 108. The hollow tube 316 can be welded to the hitch receiver 300 and extend crosswise to the hitch receiver 300. In its assembled state, the support arm 108 extends through the tube 316 of the attachment assembly 304. The position of the support arm 108 can be fixed in one of a variety of ways, including tightening a bolt through the tube of the attachment assembly to that an end of the bolt engages the support arm 108 or extends through an opening in the support arm 108, for example.

In one embodiment, a first adjustment point 320 is attached to the support arm 108. The first attachment point 320 can be shaped to receive a threaded rod 324. The first attachment point 320 and a second adjustment point 322, such as a threaded nut, can be attached to the attachment assembly 304. The second attachment point 322 can be welded onto the attachment assembly. The second attachment point 322 can be shaped to receive the threaded rod 324. When the threaded rod 324 is received by the first attachment point 320 and the second attachment point 322, the rod 324 can be moved through the first 320 and second attachment points 322 to adjust the lateral position of the support arm 108. In some embodiment, the end of the threaded rod 312 has a ¾″ drive for turning the threaded rod 324.

In this example, a second hitch receiver 312 can be attached to the attachment assembly 304. The second hitch receiver 312 can be attached to a top side 316 of the attachment assembly 304. The hitch receiver 300 can be attached to a vehicle trailer hitch, leaving the vehicle with no available hitch to connect a trailer or other towing attachment. The second hitch receiver 312 can allow a user to tow a trailer or other attachment without having to remove the spare tire holder 50. When a user wishes to tow a trailer or other attachment with the second hitch receiver 312, the wheel mounting portion 104 can be placed in an upright position (shown as the first position in FIG. 3) against a rear side of a vehicle. The upright position can provide additional clearance between the spare tire 100 and a trailer or other attachment that a user is towing. The openings 216 in support plate 206 can allow a user to move the spare tire 100 away from the second hitch receiver 312 and the attachment by adjusting the position of the support plate 206.

The second hitch receiver 312 can be shaped to receive a hitch 302, which can be any commercially available hitch. The hitch 302 can be the trailer hitch of a vehicle. The hitch 302 can be drop down hitch so that the hitch 302 is at the appropriate height to tow a trailer or other attachment. Alternately, or additionally, the second hitch receiver 312 can be shaped to receive a hitch adapter 303, which can be any commercially available hitch adapter. The hitch adapter 303 can have a first side and a second side. The first side can be oriented towards the wheel side 51 of the spare tire holder 50, and the second side can be oriented towards the mounting side 52 of the spare tire holder 50. The second side can be shaped to fit into a vehicle trailer hitch receiver. A trailer hitch with ball (not shown) can be received in the second hitch receiver 312 to tow a trailer, for example. The hitch adapter 303 can be shaped such that, when received in the second hitch receiver 312, the hitch adapter increases the clearance between a rear side (e.g., bumper) of a vehicle and the hitch receiver. In some embodiments, the hitch adapter 303 can be included in place of the second hitch receiver 312.

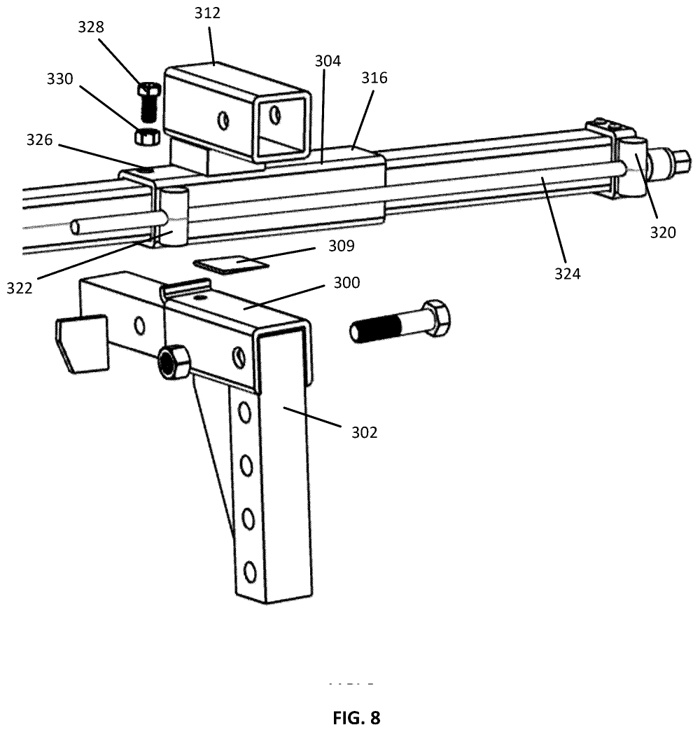

FIG. 8 is a partially exploded view of a first end 110 portion of a support arm 108 with an attachment assembly 304, in accordance with an embodiment of the present disclosure. The attachment assembly 304 can have an opening 326 in a tube 316 of the attachment assembly. The opening 326 can be shaped to receive a bolt 328. A nut 330 can be attached to the tube 316 of the attachment assembly 304 so that the opening in the nut is aligned with the opening 326 in the tube 316 of the attachment assembly 304. The nut 330 can be welded to the attachment assembly 304. The nut can be shaped to receive bolt 328. When the bolt 328 is received by the opening 326 in the tube 316, the bolt 328 can be screwed down until it contacts the support arm 108, thereby locking the support arm 108 into a fixed position. This prevents the support arm 114 from moving through or relative to the attachment assembly 304. A shim 309 can be included between the hitch receiver 300 and the attachment assembly 304 to level the support arm 108.

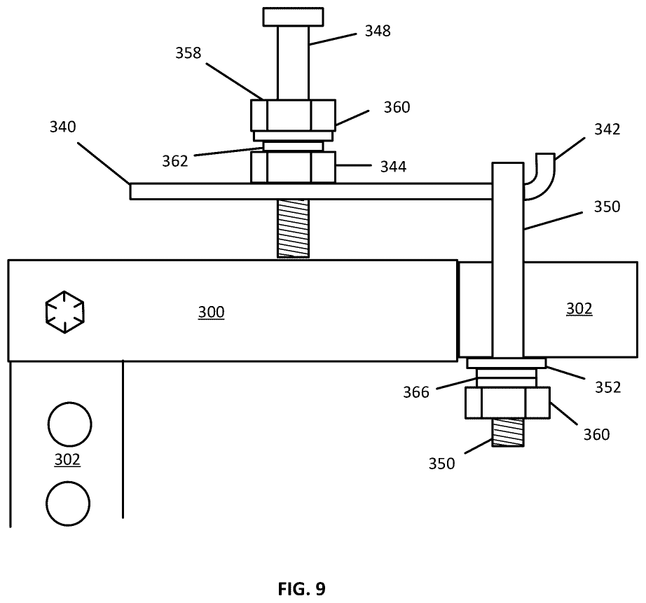

FIG. 9 illustrates a partially exploded side view showing a hitch 302 received in a hitch receiver 300, in accordance with an embodiment of the present disclosure. In some embodiments, the hitch receiver 300 is attached to a hitch 302 at a single mounting point. In another embodiment, an additional point of attachment is provided to further secure the hitch receiver 300 to the hitch 302. A hitch plate 340 can have an opening 346 shaped to receive a bolt 348. The hitch plate 340 can have an upwardly curved end 342. A nut 344 can be shaped to attach to the hitch plate 340 over the opening in the hitch plate 346. The nut 344 can be welded to the hitch plate 340 in some embodiments. A U-bolt 350 or equivalent can be placed over an end of the hitch plate 340 and retained by the upwardly curved end 342 of the hitch plate 340. The U-bolt can be placed over the hitch plate 340 so that the plate is secured between the U-bolt and the hitch 302. The bolt 348 can be screwed through nut 344 until it contacts the hitch 302.

The hitch receiver 300 can have an opening aligned with the opening 346 in the hitch plate 340 and is shaped to receive bolt 348. An attachment plate 352 can have openings 356 shaped and arranged to receive ends of the U-bolt 350. An attachment nut 354 can be shaped to receive the bolt end of the U-bolt 350. The attachment nut 354 can be placed over the attachment plate 352 so that the attachment plate 352 is between the attachment nut 354 and a bottom side of the hitch 302. When the U-bolt 350 is received by both the attachment plate 352 and the attachment nut 354, the nut 344 can be tightened over the attachment plate 352 to secure the bolt side of the U-bolt 350 to the bottom side of the hitch. This can also secure the plate 340 to a top side of the hitch 302, as the U-bolt 350 is placed over an end of the plate 342 and tightened onto a top side of the hitch 300.

A mounting nut 358, a mounting washer 360, and a mounting lock washer 362 can also be shaped to receive bolt 348. The mounting nut 358, mounting washer 360, and mounting lock washer 362 can be threaded onto the bolt 348, then the bolt 348 can be screwed through nut 344 so that the mounting nut 358, washer 360, and lock washer 362 are between the head of bolt 348 and nut 344. When the bolt 348 contacts the hitch 302, the mounting nut 358 can be tightened to secure the bolt 348. An attachment washer 364 and an attachment lock washer 366 can also be shaped to receive U-bolt 350. The attachment washer 364 and attachment lock washer 366 can be threaded onto the bolt side of the U-bolt 350, then the attachment nut 354 can be placed over so that the attachment washer 364 and lock washer 366 are between the attachment plate 352 and the attachment nut 354. The attachment nut 354 can then be tightened to secure the attachment plate 352.

### Further Example Embodiments

The following examples pertain to further embodiments, from which numerous permutations and configurations will be apparent.

Example 1 is a spare tire holder including a wheel mounting portion configured to attach to a wheel of a mounted spare tire. The spare tire holder also includes a support arm having a first end and a second end, the second end having a mounting bracket. The wheel mounting portion is pivotably attached to the mounting bracket, thereby enabling the wheel mounting portion to pivot between a first position and a second position.

Example 2 includes the spare tire holder of Example 1 and further includes a pivot arm extending from a first end to a second end, the first end attached to the wheel mounting portion, and the second end pivotally attached to the mounting bracket. The wheel mounting portion is pivotably attached to the mounting bracket via the pivot arm.

Example 3 includes the spare tire holder of Example 2 and further includes an attachment bracket on the pivot arm and an attachment post on the mounting bracket. A spring is shaped to connect to the attachment bracket at a first end of the spring and to the attachment post at a second end of the spring.

Example 4 includes the spare tire holder of Example 2 and further includes a first and second retaining hole on the mounting bracket. The first retaining hole and the second retaining hole are shaped to receive a pin. In the first position of the wheel mounting portion, the pin is received in the first retaining hole, and in the second position of the wheel mounting portion, the pin is received in the second retaining hole.

Example 5 includes the spare tire holder of Example 1 and further includes a mounting plate with a mounting side, a wheel side, and a support plate spaced from the mounting plate. The support plate is configured to attach to the wheel of a mounted spare tire. A beam extends longitudinally from a first end to a second end. The first end is attached to the mounting side of the mounting plate, and the second end is attached to the support plate so that the beam connects and is positioned between the mounting plate and the support plate.

Example 6 includes the spare tire holder of Example 5 and further includes a pivot arm. The support plate is pivotably attached to the pivot arm. An opening in the support plate is shaped to receive an adjustment pin, and an opening in the pivot arm is also shaped to receive the adjustment pin.

Example 7 includes the spare tire holder of Example 5 and further includes a beam gusset attached to the beam. The beam gusset extends longitudinally from a first end to a second end. The first end is attached to the mounting side of the mounting plate and the second end is attached to the support plate so that the beam gusset connects and is positioned between the mounting plate and the support plate.

Example 8 is a spare tire holder including a support plate configured to attach to a wheel of a mounted spare tire and a pivot arm. An opening in the support plate is shaped to receive an adjustment pin, and an opening in the pivot arm shaped to receive the adjustment pin. The support plate is pivotably attached to the pivot arm.

Example 9 includes the spare tire holder of Example 8 and further includes a support arm having a first end and a second end. The second end has a mounting bracket. The pivot arm is pivotably attached to the mounting bracket, thereby enabling the pivot arm to pivot between a first position and a second position.

Example 10 includes the spare tire holder of Example 8 and further includes a main opening in the support plate shaped to receive a bolt and a main opening in the pivot arm shaped to receive a bolt. The support plate is pivotably attached to the pivot arm via the bolt.

Example 11 includes the spare tire holder of Example 10 and further includes a first stop on the support plate. The first stop is shaped to stop rotation of the support plate by catching on the pivot arm.

Example 12 includes the spare tire holder of Example 11 and further includes a second stop on the support plate. The second stop is shaped to stop rotation of the support plate by catching on the pivot arm.

Example 13 includes the spare tire holder of Example 8 and further includes a mounting bracket. The mounting bracket is attached to the pivot arm on an opposite end of the pivot arm from the support plate. The spare tire holder also includes a support arm having a first end and a second end, the second end being attached to the mounting bracket.

Example 14 includes the spare tire holder of Examples 1 or 13, where the first end of the support arm has a hitch receiver shaped to receive a hitch. An axis of the hitch receiver is oriented transversely to the support arm.

Example 15 includes the spare tire holder of Example 14 and further includes an attachment assembly shaped to receive the first end of the support arm. A bottom side of the attachment assembly is attached to a top side of the hitch receiver.

Example 16 includes the spare tire holder of Example 15 and further includes a second hitch receiver attached to a top side of the attachment assembly.

Example 17 includes the spare tire holder of Example 16 and further includes a spacer. The second hitch receiver is attached to the top side of the attachment assembly via the spacer.

Example 18 includes the spare tire holder of Example 15 and further includes a rod, a first adjustment point, and a second adjustment point. The first adjustment point has an opening shaped to receive the rod, and the first adjustment point is attached to the support arm. The second adjustment point has an opening shaped to receive the rod, and the second adjustment point is attached to the attachment assembly.

Example 19 includes the spare tire holder of Example 15 and further includes an opening in a top side of the attachment assembly. A nut is also attached to the top side of the attachment assembly, and the nut is aligned with the opening. A bolt is shaped to screw into the nut and contact with the support arm.

Example 20 includes the spare tire holder of Example 14 and further includes a support arm gusset that connects and is positioned between the support arm and the hitch receiver. A top side of the hitch receiver is attached to a bottom side of the support arm.

Example 21 includes the spare tire holder of Example 14 and further includes a hitch plate with an opening in the hitch plate shaped to receive a bolt. The hitch plate has an upwardly curved end. A nut is shaped to be attached to the hitch plate over the opening in the hitch plate, and the nut is shaped to receive the bolt. A U-bolt is shaped to be placed over the upwardly curved end of the hitch plate and a hitch so that the hitch plate is between the hitch and the U-bolt. An attachment plate has an opening in the attachment plate shaped to receive the U-bolt. An attachment nut is shaped to receive the U-bolt. The attachment plate and the attachment nut are constructed to secure the U-bolt on a bottom side of the hitch.

Example 22 includes the spare tire holder of Example 21 and further includes a mounting nut, a mounting washer, and a mounting lock washer shaped to receive the bolt. An attachment washer and an attachment lock washer are also shaped to receive the U-bolt and to secure the attachment plate to the bottom side of the hitch.

Example 23 includes the spare tire holder of Examples 2 or 8 and further includes a limiting stop on the pivot arm. The limiting stop configured and arranged to limit a range of movement of the pivot arm.

Example 24 is a spare tire holder including a mounting plate with a mounting side and a wheel side. A beam extends longitudinally between a first end and a second end. The first end is attached to and extends transversely away from the mounting side of the mounting plate. A support plate is attached to the second end of the beam so that the beam extends between and connects the mounting plate and the support plate. A pivot arm is also included, and the support plate is pivotably attached to the pivot arm. An attachment bracket is included on the pivot arm. A mounting bracket has a first retaining hole and a second retaining hole. The first retaining hole and second retaining hole are shaped to receive a pin. A lower attachment post is attached to a top portion of the mounting bracket. A spring is attached to the attachment bracket and the attachment post. A support arm is attached to a bottom portion of the mounting bracket.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

1. A spare tire holder assembly for a vehicle, comprising:
a wheel mounting portion configured to attach to a wheel of a mounted spare tire; and
a support arm having a first end and a second end, the second end having a mounting bracket;
wherein the wheel mounting portion is pivotably attached to the mounting bracket, thereby enabling the wheel mounting portion to pivot between a first position and a second position.

2. The spare tire holder assembly of claim 1, further comprising:
a pivot arm extending from a first end to a second end, the first end attached to the wheel mounting portion, and the second end pivotally attached to the mounting bracket;
wherein the wheel mounting portion is pivotably attached to the mounting bracket via the pivot arm.

3. The spare tire holder assembly of claim 2, further comprising:
an attachment bracket on the pivot arm;
an attachment post on the mounting bracket; and
a spring shaped to connect to the attachment bracket at a first end of the spring and to the attachment post at a second end of the spring.

4. The spare tire holder assembly of claim 2, wherein the mounting bracket defines a first retaining hole and a second retaining hole, wherein, in the first position of the wheel mounting portion, the pin is received in the first retaining hole, and in the second position of the wheel mounting portion, the pin is received in the second retaining hole.

5. The spare tire holder assembly of claim 1, wherein the wheel mounting portion comprises:
a mounting plate with a mounting side and a wheel side;
a support plate spaced from the mounting plate, wherein the support plate is configured to attach to the wheel of a mounted spare tire; and
a beam extending longitudinally from a first end to a second end, the first end attached to the mounting side of the mounting plate and the second end attached to the support plate so that the beam connects and is positioned between the mounting plate and the support plate.

6. The spare tire holder assembly of claim 5, further comprising:
a pivot arm, wherein the support plate is pivotably attached to the pivot arm;
an opening in the support plate shaped to receive an adjustment pin; and
an opening in the pivot arm shaped to receive the adjustment pin.

7. The spare tire holder assembly of claim 5, further comprising a beam gusset attached to the beam, wherein the beam gusset extends longitudinally from a first end to a second end, the first end attached to the mounting side of the mounting plate and the second end attached to the support plate so that the beam gusset connects and is positioned between the mounting plate and the support plate.

8. A spare tire holder comprising:
a pivot arm having a first end portion and a second end portion;
a support plate movably attached to the first end portion of the pivot arm and configured to attach to a wheel of a mounted spare tire, the support plate defining at least one pin opening;
a mounting bracket on the second end portion of the pivot arm; and
a support arm extending crosswise to the pivot arm and having a first end and a second end, wherein the mounting bracket is fixedly attached to the first end of the support arm so that pivot arm is pivotably attached to the support arm via the mounting bracket, thereby enabling the pivot arm to pivot between a first position and a second position.

9. The spare tire holder of claim 8, wherein the support plate defines a fastener opening configured to receive a bolt, and wherein the support plate is pivotably attached to the pivot arm via the bolt.

10. The spare tire holder of claim 9, further comprising:
a first stop on the support plate, the first stop configured to stop rotation of the support plate in a first direction by engagement with the pivot arm; and
a second stop on the support plate, the second stop configured to stop rotation of the support plate in a second direction by engagement with the pivot arm.

11. The spare tire holder of claim 10, further comprising:
a mounting bracket attached to the pivot arm on an opposite end of the pivot arm from the support plate; and
a support arm having a first end and a second end, the second end being attached to the mounting bracket.

12. The spare tire holder of claim 11, wherein the first end of the support arm has
a hitch receiver on the first end of the support arm and oriented transversely to the support arm, the hitch receiver shaped to receive a hitch; and
an attachment assembly shaped to receive the first end of the support arm, wherein a bottom side of the attachment assembly is attached to a top side of the hitch receiver.

13. The spare tire holder of claim 12, further comprising a second hitch receiver attached to a top side of the attachment assembly.

14. The spare tire holder of claim 13, further comprising:
a rod;
a first adjustment point with an opening shaped to receive the rod, wherein the first adjustment point is attached to the support arm;
a second adjustment point with an opening shaped to receive the rod, wherein the second adjustment point is attached to the attachment assembly.

15. The spare tire holder of claim 14, wherein the attachment assembly defines a fastener opening and the spare tire holder further comprises:
a nut attached to attachment assembly and aligned with the fastener opening; and
a bolt configured to screw into the nut and engage the support arm.

16. The spare tire holder of claim 14, further comprising:
a support arm gusset that connects and is positioned between the support arm and the hitch receiver, wherein a top side of the hitch receiver is attached to a bottom side of the support arm.

17. The spare tire holder of claim 12, further comprising:
a hitch plate with an opening in the hitch plate shaped to receive a bolt, the hitch plate having an upwardly curved end;
a nut shaped to be attached to the hitch plate over the opening in the hitch plate, the nut being shaped to receive the bolt;
a U-bolt shaped to be placed over the upwardly curved end of the hitch plate and a hitch such that the hitch plate is between the hitch and the U-bolt;
an attachment plate with an opening in the attachment plate shaped to receive the U-bolt; and
an attachment nut shaped to receive the U-bolt;
wherein the attachment plate and the attachment nut are constructed to secure the U-bolt on a bottom side of the hitch.

18. The spare tire holder of claim 17, further comprising:
a mounting nut, a mounting washer, and a mounting lock washer shaped to receive the bolt; and
an attachment washer, and an attachment lock washer shaped to receive the U-bolt and to secure the attachment plate to the bottom side of the hitch.

19. A spare tire holder comprising:
a mounting plate with a mounting side and a wheel side;
a beam extending longitudinally between a first end and a second end, the first end attached to and extending transversely away from the holder side of the mounting plate;
a support plate attached to the second end of the beam so that the beam extends between and connects the mounting plate and the support plate;
a pivot arm, the support plate being pivotably attached to the pivot arm;
an attachment bracket on the pivot arm;
a mounting bracket with a first retaining hole and a second retaining hole, the first retaining hole and second retaining hole being shaped to receive a pin;
a lower attachment post attached to a top portion of the mounting bracket;
a spring attached to the attachment bracket and the attachment post;
a support arm attached to a bottom portion of the mounting bracket.

20. The spare tire holder of claim 19, further comprising a limiting stop on the pivot arm, the limiting stop configured and arranged to limit a range of movement of the pivot arm.
